(19) United States
(12) Patent Application Publication
(10) Pub. No.: US 2011/0242144 A1
(43) Pub. Date: Oct. 6, 2011

(54) DISPLAY APPARATUS FOR DISPLAYING IMAGE

(75) Inventor: Kohji OHNISHI, Kobe-shi (JP)

(73) Assignee: FUJITSU TEN LIMITED, KOBE-SHI (JP)

(21) Appl. No.: 13/071,977

(22) Filed: Mar. 25, 2011

(30) Foreign Application Priority Data
Mar. 31, 2010 (JP) 2010-080715

(51) Int. Cl. G09G 5/10

(52) U.S. Cl. 345/690

(57) ABSTRACT

A display apparatus for displaying an image determines whether or not an image to be displayed on a screen is a specific image including a mark. In the case where the display apparatus determines the image to be the specific image, the display apparatus controls a backlight so as to illuminate the screen so that areas other than an area including a mark on the specific image are illuminated with less brightness than the brightness of the area including the mark.

### BACKGROUND OF THE INVENTION

1. Field of the Invention

The invention relates to technologies for displaying an image on a screen.

2. Description of the Background Art

Recently, energy-saving technologies have become important against the background of environmental problems, and display apparatuses such as a television, a portable terminal, a personal computer, and a car navigation apparatus in which the energy-saving technologies are adopted attract attention.

The energy-saving technologies that are adopted for such display apparatuses, for example, include a technology to significantly reduce power consumption by controlling a backlight effectively.

This technology is explained more closely. A display apparatus turns on, in response to brightness of an image, each of a plurality of LEDs which comprise a backlight, corresponding to a display area of a display screen. Thereby, the display apparatus can turn off the LEDs corresponding to relatively dark area with low brightness, and their power consumption can be reduced. These technologies are disclosed in Japanese Patent Application Laid-open Publication No. 2009-251331.

However, basically in the case where a specific image that is comprised of illustrations having few low-brightness areas is displayed, a backlight is controlled to be illuminated in a certain brightness, and therefore, it is difficult to reduce the power consumption.

### SUMMARY OF THE INVENTION

According to one aspect of this invention, a display apparatus for displaying an image includes: a display unit having a screen; a backlight that illuminates the screen and that includes a plurality of light sources; a controller that determines whether or not an image to be displayed on the screen is a specific image including a mark; and a backlight controller that controls the backlight so as to illuminate areas other than an area including the mark on the specific image with less brightness than a brightness of the area including the mark, in the case where the image is determined to be the specific image.

In the case where an image to be displayed on a screen is determined to be a specific image including a mark, a backlight is controlled so as to illuminate areas other than an area including a mark in a specific image with less brightness than the brightness of the area including the mark. Thereby, it is possible to reduce power consumption while improving visibility of the specific image for a user.

According to another aspect of this invention, the display apparatus is installed on a vehicle. The specific image is a car navigation image and the mark is a vehicle location mark included in the car navigation image.

Thereby, it is possible to reduce power consumption while fulfilling a guidance function with improved user's visibility of the mark.

According to another aspect of this invention, the display apparatus further includes an image controller that sets an external area other than an area within a predetermined range centered on the vehicle location mark on the car navigation image, to a black image. The backlight controller controls the backlight so as to illuminate the black image with a lower intensity than the area including the mark.

In a car navigation image, an external area other than an area within a predetermined range centered on a vehicle location mark is set to a black image, and a backlight is controlled so as to illuminate the black image with a lower intensity than an area including a mark. Thereby, it is possible to reduce power consumption while fulfilling a guidance function with improved user's visibility of the mark.

Therefore, an object of the invention is to provide, in a display apparatus, a technology for reducing power consumption of a backlight that illuminates a specific image having few low-brightness areas.

These and other objects, features, aspects and advantages of the invention will become more apparent from the following detailed description of the invention when taken in conjunction with the accompanying drawings.

### BRIEF DESCRIPTION OF THE DRAWINGS

FIG. 1 shows a display part;

FIG. 2 is a system configuration diagram of on-vehicle equipment;

FIG. 3 shows a displayed image and a backlight;

FIG. 4 is a flowchart showing controls executed by on-vehicle equipment;

FIG. 5 shows a displayed image and a backlight;

FIG. 6 shows a displayed image and a backlight;

FIG. 7 shows a displayed image and a backlight;

FIG. 8 shows a displayed image and a backlight;

FIG. 9 shows a displayed image and a backlight;

FIG. 10 shows a display part; and

FIG. 11 shows a display part.

### DESCRIPTION OF THE EMBODIMENTS

Technologies explained hereinbelow are applied to various display apparatuses in which a display part is installed. However, on-vehicle equipment that is an example of the display apparatuses is explained for convenience. Hereafter, explanation of on-vehicle equipment is divided into three parts, a structure of a display part to be installed in on-vehicle equipment, a configuration of on-vehicle equipment, and a control of on-vehicle equipment with reference to attached drawings.

### Representative Embodiment

<Structure of a Display Part to be Installed in on-Vehicle Equipment>

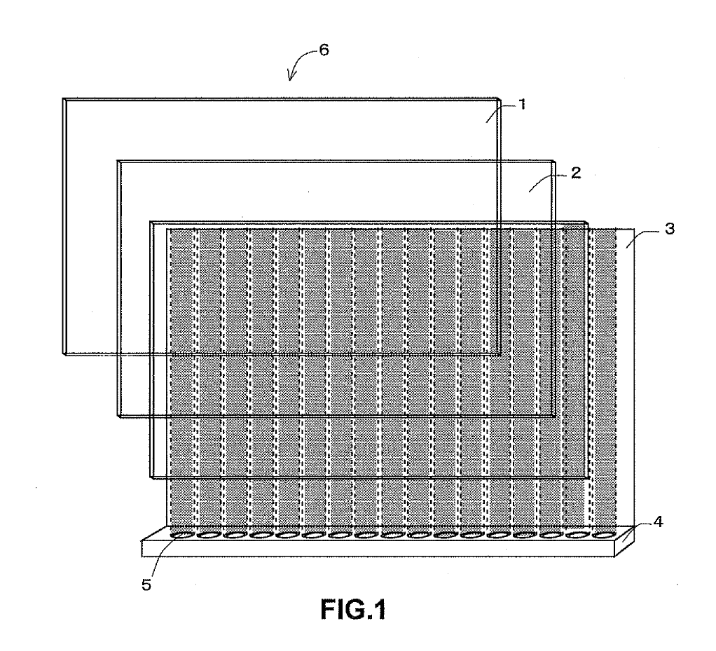

A structure of a display part included in on-vehicle equipment to be installed on a vehicle is explained based on FIG. 1. A display part 6 includes a color filter 1, a liquid crystal layer 2, TFT (Thin Film Transistor) 3, a backlight 4, and the like.

The color filter 1 is a film on which three primary colors (RGB) are printed for each pixel. The liquid crystal layer 2 functions as a shutter that transmits light by changing its molecular array when voltage is applied. The TFT 3 is a thin-film transistor that transmits light of the backlight 4 to the color filter 1 side by controlling electrodes arrayed in a matrix pattern, applying voltage to an intended cell in the matrix pattern and then changing the molecular array of liquid crystal of the liquid crystal layer 2 corresponding to the intended cell. The backlight 4 includes a plurality of light emitting diodes (LED) 5 as light sources which are arrayed in line on one side of a rectangular display part 6. A screen of the display part 6 includes the color filter 1, the liquid crystal layer 2 and the TFT 3, and this screen is illuminated by the backlight 4.

The TFT 3 and the backlight 4 of the display part 6 which is laminated with these materials are controlled by a controller of on-vehicle equipment. As a result, an image is displayed on a screen of the display part 6.

The backlight 4 is an edge-light type backlight having simple structure, and therefore, it can be said that this type is an optimum structure for on-vehicle equipment for which the thin display part 6 is required. Since the edge-light type backlight 4 includes a plurality of LEDs 5 arrayed in line on one side of the rectangular display part 6, their lights weaken with an increase in distance from the LED positioned side toward the opposite side of the display part 6. Therefore, the backlight 4 has a polarizing plate and the like to prevent the problem, in other words, to uniform the lights in the display part 6.

<Configuration of On-Vehicle Equipment>

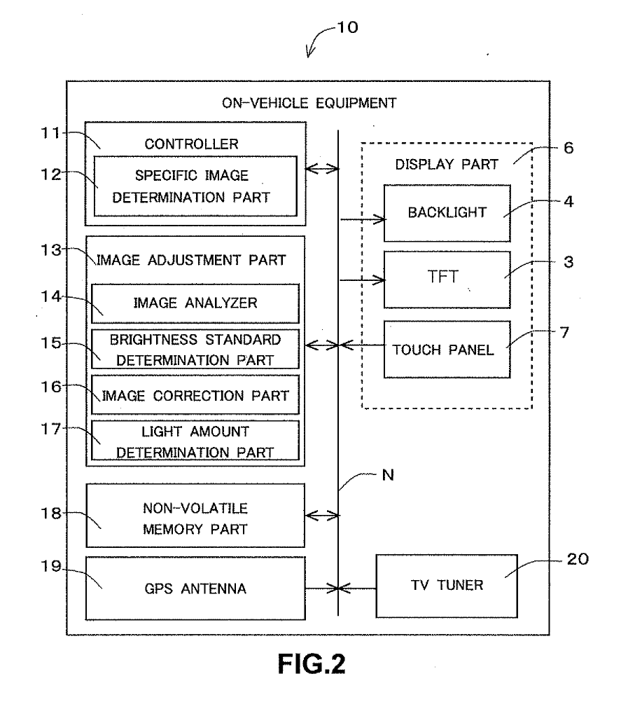

Next, the configuration of the on-vehicle equipment is explained based on FIG. 2. An on-vehicle equipment 10 includes a controller 11, an image adjustment part 13, a non-volatile memory part 18, a GPS antenna 19, a TV tuner 20, the display part 6 and the like, which are electrically connected to bus N that is capable of data communication.

The controller 11 is a microcomputer including devices such as CPU, ROM in which control program and the like are stored. For example, a specific image determination part 12 included in the controller 11 fulfills a specific image determination function. The function is a function that the specific image determination part 12 determines whether or not an image to be displayed on the display part 6 is a specific image. Details of the specific image determination function are described later.

The image adjustment part 13 is LSI (Large Scale Integration). For example, an image analyzer 14, a brightness standard determination part 15, a light amount determination part 17 and an image correction part 16 included in the image adjustment part 13 fulfill an image analyzing function, a brightness standard determination function, a light amount determination function and an image correction function respectively.

The image analyzing function is a function that the image analyzer 14 analyzes an image to be displayed on the display part 6. The brightness standard determination function is a function that the brightness standard determination part 15 determines a brightness standard of an image to be input. The image correction function is a function that the image correction part 16 corrects an image based on the brightness standard and light emission amount. The light amount determination function is a function that the light amount determination part 17 determines the light amount to be emitted by the backlight 4. Details of the image analyzing function, the brightness standard determination function, the light amount determination function and the image correction function are described later.

The non-volatile memory part 18 is flash memory such as EEPROM and stores data and the like on a car navigation system. The data on the car navigation system, for example, refers to the data such as a map image, a vehicle location mark, a bearing mark.

The GPS antenna 19 is installed in the on-vehicle equipment 10 and is an antenna that receives GPS data showing where a vehicle is located on the earth, from a GPS satellite.

The TV tuner 20 is a device that fulfills functions such as receiving digital TV broadcasting data and demodulating it into predetermined data.

The display part 6 includes the above-mentioned backlight 4, TFT 3 and the like. The display part 6 further includes a touch panel 7 that accepts user's operation on a display screen.

<Control of On-Vehicle Equipment>

The controller 11 displays, on the display part 6, TV data received by the TV tuner 20 in cooperation with the image adjustment part 13 after the touch panel 7 included in the display part 6 accepts user's operation of TV mode setting.

Also, the controller 11 reads out a map image and the like stored in the non-volatile memory part 18 based on GPS data received from the GPS antenna 19 and displays them on the display part 6, after the touch panel 7 included in the display part 6 accepts user's operation of car navigation mode setting.

In addition, the controller 11 makes various functions selectable for a user by displaying a menu screen that shows a mark and the like to select TV mode setting or car navigation mode setting, on the display part 6.

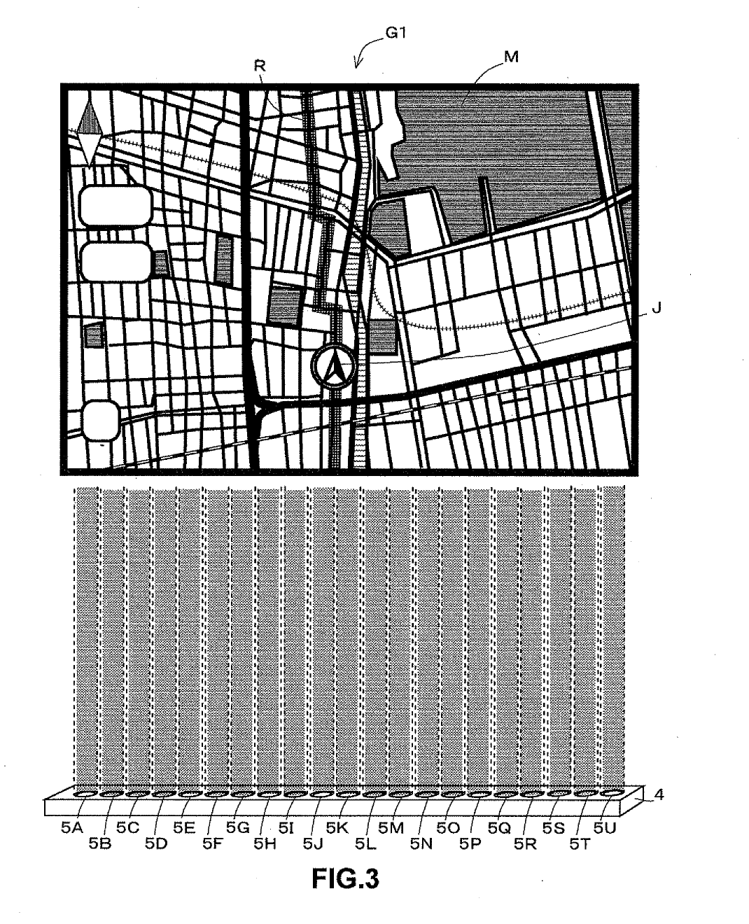

Furthermore, the controller 11 enables a user to select, on the menu screen, Eco-mode that reduces power consumption. In the case where the Eco-mode is not selected by the user, the controller 11 executes a control to make all the LEDs 5 comprising the backlight 4 emit light evenly, as shown in FIG. 3.

As shown in FIG. 3, the 21 LEDs 5 are explained by assigning addresses to each LED 5, such as 5A for the first LED 5 from the left, 5B for the second LED 5 from the left, 5C for the third LED 5 from the left, and the like.

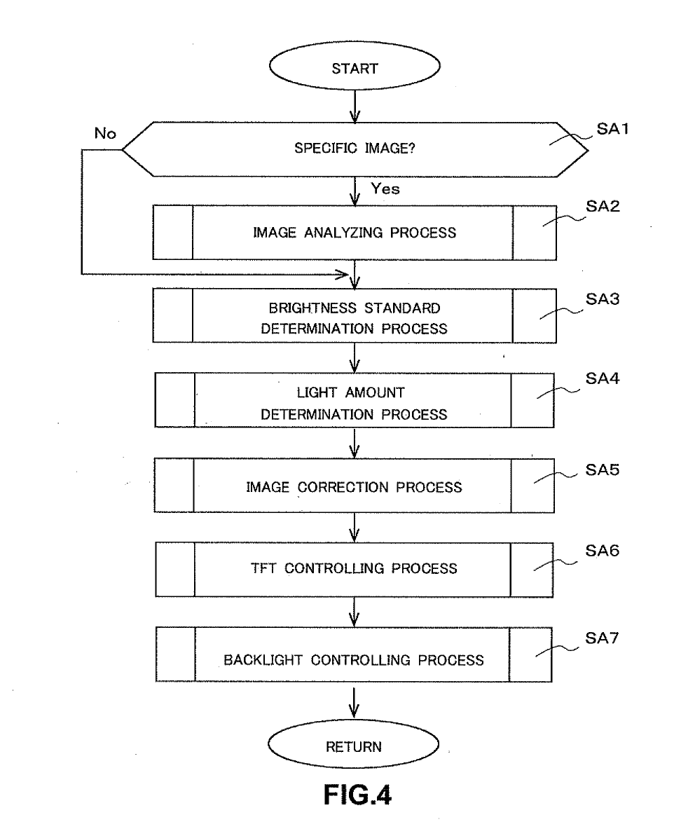

On the other hand, in the case where Eco-mode is selected by a user, the controller 11 executes a control shown in FIG. 4 at predetermined tine periods until the power source of on-vehicle equipment is turned off by a user, or the Eco-mode is turned off by the user.

A case where the controller 11 executes the control shown in FIG. 4 when the Eco-mode is selected by a user is explained hereinbelow.

In a step SA1, the specific image determination part 12 determines whether an image to be displayed on the display part 6 is a specific image having a specific characteristic. In the case where the image is determined to be a specific image (Yes in the step SA1), the step moves to a step SA2. In the case where the image is not determined to be a specific image (No in the step SA1), the step moves to a step SA3.

A specific image is not an image (a gradation image having gradual brightness from a bright section to a dark section) having many low-brightness areas included in motion pictures, for example, from TV data or recorded data on a DVD and the like, but rather is an image having few low-brightness areas, comprised of illustrations having few gradation expressions such as a car navigation image including a vehicle location mark. In other words, the specific image can also be said to be a non-gradation image having little gradual brightness transition from a bright section to a dark section. Hereinbelow, a car navigation image including a vehicle location mark is explained as an example of the specific image.

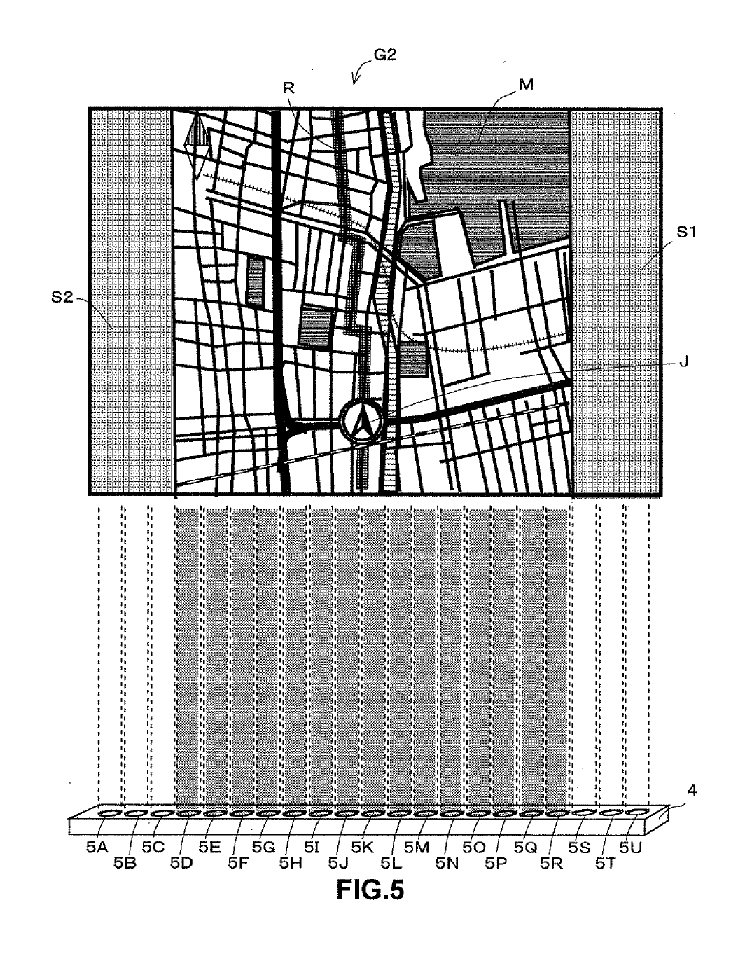

In the step SA2, as shown in FIG. 5, the image analyzer 14 included in the image adjustment part 13 determines where a vehicle location mark J included in a car navigation image G2 is located on the car navigation image G2. Then, the image analyzer 14 specifies an area M within a predetermined range centered on the vehicle location mark J as well as specifying an external area S1 and an external area S2 other than the area M within a predetermined range. The area M within a predetermined range is an area including a map image for navigation guidance, and therefore, it is hereinafter referred to as “navigation guidance area” M. The image analyzer 14 sets the external area S1 and the external area S2 specified other than the navigation guidance area M, to a black image. The image analyzer 14 allocates the external area S1 and the external area S2 so that the navigation guidance area M is sandwiched in between those two external areas, in other words, the image analyzer 14 allocates the external area S1 and the external area S2 outside of respective sides (right and left side) of the navigation guidance area M. A black image refers to an image comprised of only pixels with a certain value (brightness is zero ideally) of relatively-low brightness.

However, the image analyzer 14 prohibits setting the external area to the black image in the case where the external area includes a route line R to a destination. In the case where a user sets display mode of a north-up image, in other words, a map image on which the north direction is always indicated in the upper part when the image is displayed on the display part 6, the image analyzer 14 prohibits an external area existing in a travelling direction from being set to the black image if the external area exists in a travelling direction indicated by the vehicle location mark J.

By such prohibition processes, it is possible to reduce power consumption of on-vehicle equipment without reducing convenience of car navigation system for a user. Next, the step moves to a step SA3.

In the step SA3, the brightness standard determination part 15 derives an average brightness of pixel (average brightness) in an input image. Next, the step moves to a step SA4.

In the step SA4, in the case where an input image is a specific image (YES in a step SA1), the light amount determination part 17 determines the light emission amount of a plurality of LEDs comprising the backlight 4, based on a type of an area included in a specific image, in other words, on the car navigation image G2. In other words, as shown in FIG. 5, the light amount determination part 17 determines to turn on, in a certain amount of light emission, LED 5D to LED 5R corresponding to the navigation guidance area M on the car navigation image G2. In addition, the light amount determination part 17 determines not to turn on LED 5A to LED 5C and LED 5S to LED 5U corresponding to the external area S1 and an external area S2 that are set to black images on the car navigation image G2.

In the case where an input image is not a specific image (NO in the step SA1), the light amount determination part 17 determines to turn on LEDs in such a way that light illuminating a screen is made uniform. Next, the step moves to the step SA5.

In the step SA5, the image correction part 16 included in the image adjustment part 13 adjusts (corrects) brightness of an image based on average brightness derived by the brightness standard determination part 15.

The image correction part 16 makes such a correction (hereinafter, this correction is referred to as an average brightness correction) as increasing brightness by predetermined ratio (%) corresponding to low brightness, in the case where the brightness is lower than the average brightness, and decreasing brightness by a predetermined ratio (%) corresponding to high brightness, in the case where the brightness is higher than the average brightness.

In the case where an input image is a specific image, the image correction part 16 makes the average brightness correction to all pixels in an image of the navigation guidance area M. In addition, in the case where an input image is not a specific image, the image correction part 16 makes the average brightness correction to the whole input image.

In this way, by making an average brightness correction to an image, a too-dark area becomes brighter and a too-bright area becomes darker based on average brightness. Therefore, it is possible to give a viewer soft impression as a whole image, resulting in enabling the viewer to view easily.

The image correction part 16 does not make the correction because an external area is kept as a black image in the case of a specific image, in other words, the car navigation image G2. Next, the step moves to a step SA6.

In the step SA6, in the case where an input image is a specific image, the controller 11 controls the TFT 3 to display the car navigation image G2 including a black image or a specific image corrected by the image correction part 16, on the display 6. In other words, the controller 11 controls the TFT 3 to display the car navigation image G2 on the display 6 by transmitting the light from the backlight 4 through one of three primary colors (RGB) allocated to each pixel of the color filter 1.

In the case where an input image is not the specific image, the controller 11 controls the TFT 3 in accordance with an image corrected by the image correction part 16. Next, the step moves to a step SA7.

In the step SA7, the controller 11 controls a plurality of LEDs comprising the backlight 4, based on light emission amount determined by the light amount determination part 17 included in the image adjustment part 13.

As shown in FIG. 5, in the case where an input image is a specific image, the controller 11 makes the LED 5D to the LED 5R emit light in a certain amount, which correspond to the navigation guidance area M on the car navigation image G2 and the controller 11 does not make the LED 5A to the LED 5C and the LED 5S to the LED 5U emit light, which correspond to the external area S1 and the external area S2 on the car navigation image G2.

In the case where an input image is not a specific image, the controller 11 controls the backlight 4 so that light illuminating a screen is uniform. Next, the step moves to Return.

In this way, the on-vehicle equipment 10 sets an external area other than the area M within a predetermined range centered on the vehicle location mark J, in other words, a mark included in a car navigation image that is a specific image, to a black image, and the on-vehicle equipment 10 does not make LEDs emit light, which correspond to the black image among the LEDs that are a plurality of light sources comprising the backlight 4. Therefore, also in a car navigation image, it is possible to reduce power consumption while fulfilling a guidance function with improved visibility of the mark for a user.

### MODIFICATION EXAMPLES

Although the representative embodiment of this invention has been explained, this invention is not limited to the representative embodiment mentioned above, and various modifications are possible. Modification examples of the representative embodiment are explained below. Moreover, the modifications described below may be combined arbitrarily.

### Modification Examples 1

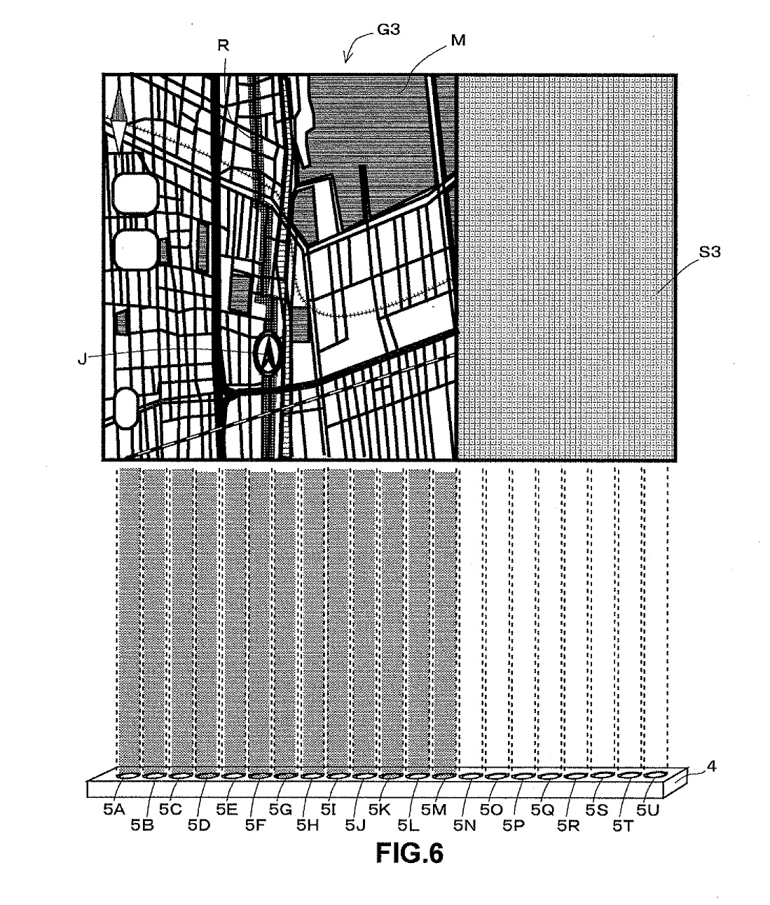

In the representative embodiment described above, the external area S1 and the external area S2 are allocated outside of both sides (right and left side) of the navigation guidance area M. However, as shown in FIG. 6, it is acceptable to allocate the external area S3 outside of either one of left or right side of the navigation guidance area M. The image analyzer 14 sets the allocated external area S3 to a black image.

In this ease, as shown in FIG. 6, the light amount determination part 17 determines to turn on, in a certain amount of light emission, the LED 5A to LED 5M corresponding to the area M within a predetermined range in a car navigation image G3. In addition, the light amount determination part 17 determines not to turn on LED 5N to the LED 5U corresponding to the external area S3 on the car navigation image G3.

In the step SA7, as shown in FIG. 6, the controller 11 makes the LED 5A to the LED 5M emit light in a certain amount, which correspond to the area M within a predetermined range on the car navigation image G3, and the controller 11 does not make the LED 5N to the LED 5U emit light, which correspond to the external area S3 on the car navigation image G3.

Thereby, it is possible to achieve similar effect as the representative embodiment described above, in other words, it is possible to reduce power consumption while fulfilling a guidance function with improved visibility of the mark J for a user.

### Modification Examples 2

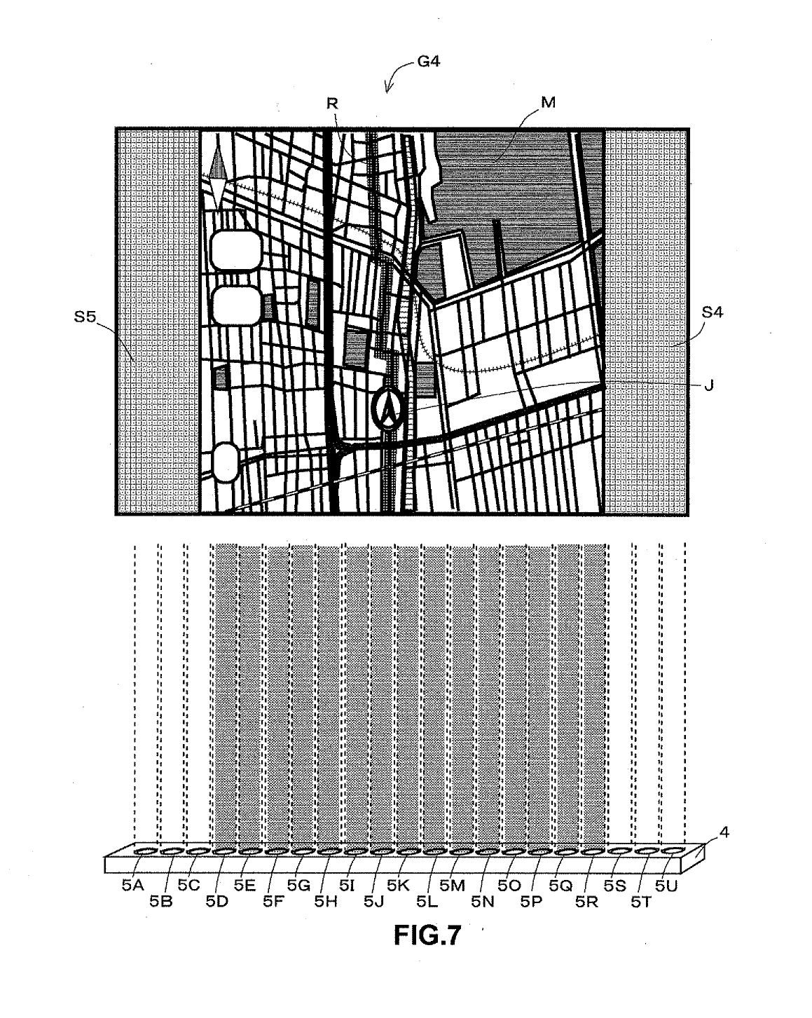

In the representative embodiment described above, an area within a predetermined range centered on the vehicle location mark J on a map image is specified as the navigation guidance area M. However, as shown in FIG. 7, it is acceptable to specify an area established by scaling down a wider range of a map image to fit within a predetermined range, as the navigation guidance area M. In this way, the image analyzer 14 specifies the navigation guidance area M as well as an external area S4 and an external area S5 other than the navigation guidance area M.

In this case, the image analyzer 14 may increase a reduction ratio of the navigation guidance area M with an increase in distance from the vehicle location mark J.

Thereby, the vehicle location mark J that is an important indication in a navigation image and a peripheral image of the vehicle location mark J are displayed in detail, but on the other hand, amount of information of the area that has less importance than the vehicle location mark J and its peripheral area on the image is reduced. And therefore, it is possible to reduce power consumption while fulfilling a guidance function with improved visibility of the mark J for a user.

### Modification Examples 3

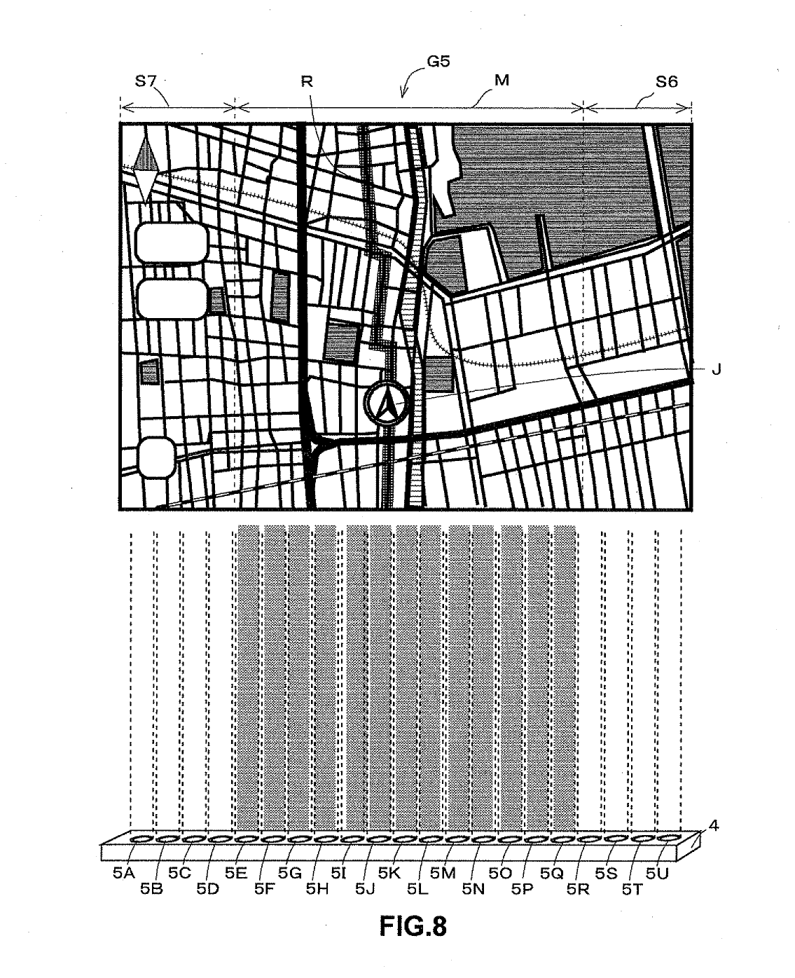

In the representative embodiment described above, as shown in FIG. 5, the external area S1 and the external area 52 allocated outside of the navigation guidance area M are set to black images. However, it is acceptable to set them to map images, not black images. In this case, as shown in FIG. 8, the image analyzer 14 allocates an external area S6 and an external area S7 outside of both sides (right and left side) of the navigation guidance area M. The external area S6 and the external area S7 are kept as they are, not set to black images.

In this case, the image correction part 16 increases brightness of all pixels included in the external, area S6 and S7, by predetermined ratio (%), to brighten them more than the navigation guidance area M.

As shown in FIG. 8, the light amount determination part 17 determines to turn on, in a certain amount of light emission, a LED 5E to a LED 5Q corresponding to the area M within a predetermined range on the car navigation image G5. In addition, the light amount determination part 17 determines not to turn on the LED 5A to the LED 5D and the LED 5R to the LED 5U corresponding to the external area S6 and S7 on the car navigation image G5.

In the step SA7, as shown in FIG. 8, the controller 11 makes the LED 5E to the LED 5Q emit light in a certain amount, which correspond to the area M within a predetermined range on the car navigation image G5, and the controller 11 does not make the LED 5A to the LED 5D and the LED 5R to the LED 5U emit light, which correspond to the external area S6 and S7 on the car navigation image G5.

Thereby, a part of the car navigation image G5 is not set to a black image or is not scaled down. Therefore, it is possible not to reduce guidance information of the car navigation image G5 to be provided to a user. Furthermore, it is possible to reduce power consumption without turning on the LEDs comprising the backlight 4, which correspond to the external area S6 and the external area S7 as well as to increase brightness of images of the external area S6 and the external area S7 more than the brightness of the area M within a predetermined range by predetermined ratio (%) for making the information of images of external areas visible.

The light amount determination part 17 may determine light amount of LEDs corresponding to the navigation guidance area M within a predetermined range and an external area so that the vehicle location mark J included in the car navigation image G5 is displayed most brightly, and the brightness of LEDs are decreased with an increase in distance from the vehicle location mark J. In this case, the image correction part 16 increases brightness of the car navigation image G5 gradually in inverse proportion to gradual reduction of the light emission amount by the light amount determination part 17.

The controller 11 can control the light emission amount of each LED not only by simple control of turning on/off LEDs comprising the backlight 4 but also light emission amount of each LED by varying duty ratio of control current for each LED. Therefore, the controller 11 can gradually darken the LEDs with an increase in distance from the vehicle location mark J, as explained above.

Thereby, the vehicle location mark J that is an important indication in a navigation image and a peripheral image of the vehicle location mark J are displayed brightly. Furthermore, an image that has less importance than the vehicle location mark J and its peripheral image is displayed darker than the vehicle location mark J and its peripheral image. However, car navigation information to be provided to a user can be displayed, in other words, it is possible to reduce power consumption while fulfilling a guidance function with improved visibility of the mark J for a user.

### Modification Examples 4

In the representative embodiment described above, a car navigation image including a vehicle location mark is explained as an example of a specific image. However, the specific image may be an image for which a user can select various functions, in other words, a menu image on which selection marks corresponding to a plurality of functions respectively are displayed.

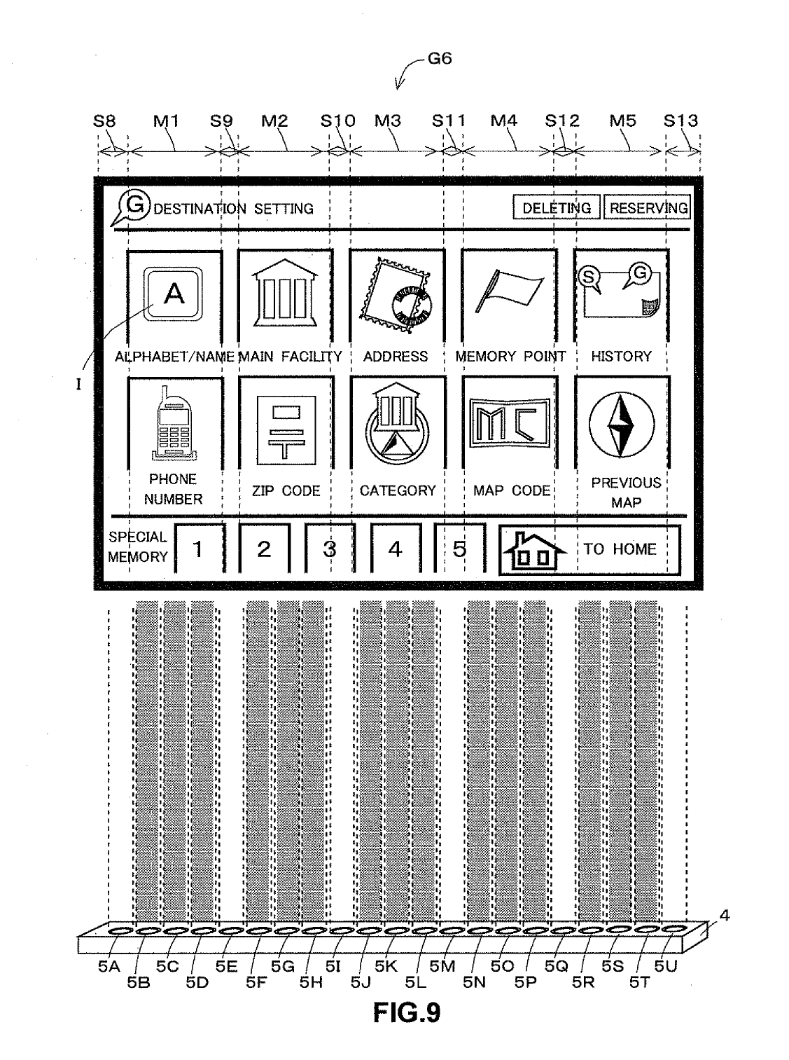

In this case, as shown in FIG. 9, the image analyzer 14 included in the image adjustment part 13 determines where a selection mark I included in a menu image G6 is located on the menu image G6. And then, the image analyzer 14 specifies an area within a predetermined range centered on the selection mark I as well as specifying an external area other than the area within a predetermined range. As shown in FIG. 9, the menu image G6 has a plurality of small and large selection marks. Therefore, if an area within a predetermined range is given to all selection marks respectively, control of light emission of all LEDs that comprise the backlight 4 must be executed eventually.

Therefore, in the case of the menu image G6, a main selection mark and a sub selection mark that is a selection mark other than the main selection mark are defined, and the image analyzer 14 specifies the area M within a predetermined range centered on the main selection mark I. The main selection mark is, for example, defined as the largest-sized mark or a selection mark for achieving the objectives of a menu screen directly. In the case of FIG. 9, the largest-sized marks are for “Alphabet/Name” and “Main facility” and others, and the selection marks for achieving the objectives of the menu screen directly are “Alphabet/Name” and “Main facility” and others for destination setting because a purpose of the menu screen is to set a destination.

According to this definition, as shown in FIG. 9, the image analyzer 14 specifies an area M1 within a predetermined range to an area M5 within a predetermined range as well as specifying an external area S8 to an external area S13 other than the area within a predetermined range.

As shown in FIG. 9, the light amount determination part 17 included in the image adjustment part 13 determines to make the following LEDs emit light in a certain amount; a LED 5B to the LED 5D, a LED 5F to a LED 5H, a LED 5J to a LED 5L, the LED 5N to a LED 5P, and the LED 5R to a LED 5T corresponding to the area M1 within a predetermined range to the area M5 within a predetermined range on the menu image G6. In addition, the light amount determination part 17 determines not to make the following LEDs emit light; the LED 5A, the LED 5E, a LED 5I, the LED 5M, the LED 5Q, and the LED 5U corresponding to the external area S8 to the external area S13 on the menu image G6.

As described above, the light amount determination part 17 may determine light amounts of the LEDs corresponding to the area M within a predetermined range and an external area so that the selection mark I included in the menu image G6 is displayed most brightly, and the LEDs become darker with an increase in distance from the selection mark I. In this case, the image correction part 16 increases brightness of the menu image G6 gradually in inverse proportion to gradual reduction of the light emission amount by the light amount determination part 17.

Thereby, the selection mark I that is an important indication on the menu image G6 and a peripheral image of the selection mark I are displayed brightly. Furthermore, an image that has less importance than the selection mark I and its peripheral image is displayed darker than the selection mark I and its peripheral image. However, menu information to be provided to a user can be displayed, in other words, it is possible to reduce power consumption while fulfilling an option providing function of the menu image.

### Modification Examples 5

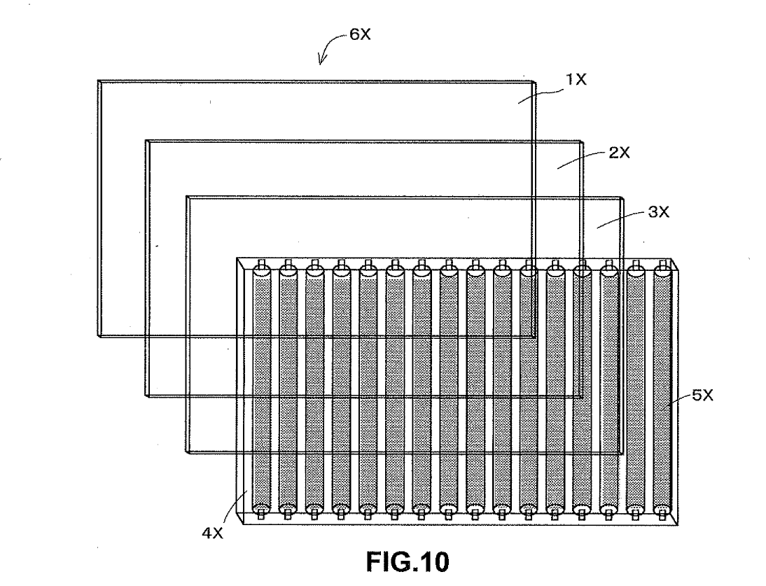

In the representative embodiment described above, the explanation is given as follows: the backlight 4 included in the display part 6 is light source including a plurality of LEDs for light emitting diodes arrayed in line, and the backlight 4 is an edge-light type backlight including a plurality of LEDs arrayed in line on one side of a rectangular display part 6X. However, as shown in FIG. 10, a directly under-type backlight in which a plurality of fluorescent lights 5X are arrayed in the reverse direction, in other words, on the back side of the display surface of the display part 6X is acceptable.

A structure of the display part 6X in this case is explained based on FIG. 10. The display part 6X includes a color filter 1X, a liquid crystal layer 2X, a TFT 3X, a backlight 4X, and the like.

The color filter 1X is a film on which three primary colors (RGB) are printed for each pixel. The liquid crystal layer 2X functions as a shutter that transmits light by changing its molecular array when voltage is applied. The TFT 3X is a thin-film transistor that transmits light of the backlight 4X to the color filter 1X side by controlling electrodes arrayed in a matrix pattern, applying voltage to an intended cell in the matrix pattern and then changing the molecular array of liquid crystal of the liquid crystal layer 2X corresponding to the intended cell. The backlight 4X is light source that includes a plurality of fluorescent lights 5X arrayed in line.

It is possible for a controller of on-vehicle equipment to display an image by controlling the emission of the fluorescent lights 5X arrayed in line, like the above-mentioned LED control method.

### Modification Examples 6

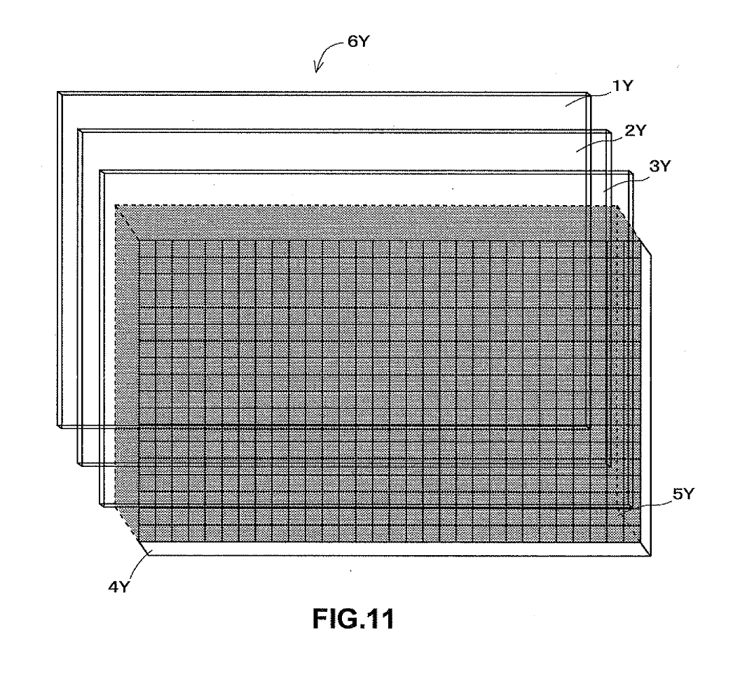

In the representative embodiment described above, the explanation is given as follows: the backlight 4 included in the display part 6 is light source including a plurality of LEDs arrayed in line, and the backlight 4 is an edge-light type backlight including a plurality of LEDs arrayed in line on one side of a rectangular display part 6. However, as shown in FIG. 11, another directly under-type backlight, a backlight 4Y, which has a plurality of LEDs arranged in a matrix pattern is positioned on opposite side to displayed direction, in other words, on the back side of the display surface of the display part 6Y is acceptable.

A structure of the display part 6Y in this case is explained based on FIG. 11. The display part 6Y includes a color filter 1Y, a liquid crystal layer 2Y, a TFT 3Y, a backlight 4Y, and the like.

The color filter 1Y is a film on which three primary colors (ROB) are printed for each pixel. The liquid crystal layer 2Y functions as a shutter that transmits light by changing its molecular array when voltage is applied. The TFT 3Y is a thin-film transistor that transmits light of the backlight 4Y to the color filter 1Y side by controlling electrodes arrayed in a matrix pattern, applying voltage to an intended cell in the matrix pattern and then changing the molecular array of liquid crystal of the liquid crystal layer 2Y corresponding to the intended cell. The backlight 4Y is light source that includes a plurality of LEDs 5Y arranged in a matrix.

It is possible for a controller of on-vehicle equipment to display an image by controlling the emission of LEDs 5Y arranged in a matrix like the above-mentioned LED control method.

Moreover, according to this structure, it is possible to control LEDs not only in line as in the representative embodiment, but also in a single cell in a matrix. Therefore, the above-mentioned area within a predetermined range can be replaced by an area inside a predetermined-sized circle centered on a mark.

### Modification Examples 7

In the step SA3 in the representative embodiment described above, the brightness standard determination part 15 derives an average brightness. However, the brightness standard determination part 15 may derive histogram data. The histogram data refers to data in which the number of pixels on an image is counted by each brightness level. If this data is graphed, it is possible to visually understand a pixel distribution corresponding to the brightness.

In this case, in the step SA5, the image correction part 16 makes a brightness correction (hereinafter, referred to as histogram correction) so that an ideal distribution is achieved based on the histogram data derived by the brightness standard determination part 15, in other words, so that a distribution with rich gradation and moderate contrast is achieved without over exposure and under exposure if the histogram data is represented in a pixel distribution corresponding to brightness.

In this way, a pixel distribution corresponding to brightness is brought close to an ideal by the histogram correction to an image, so that too-dark area becomes brighter and too-bright area becomes darker. Therefore, it is possible to give a viewer soft impression as a whole image, resulting in enabling the viewer to view easily.

While the invention has been shown and described in detail, the foregoing description is in all aspects illustrative and not restrictive. It is therefore understood that numerous other modifications and variations can be devised without departing from the scope of the invention.

What is claimed is:

1. A display apparatus that displays an image, the display apparatus comprising:
a display unit that has a screen;
a backlight that illuminates the screen and that includes a plurality of light sources;
a controller that determines whether or not an image to be displayed on the screen is a specific image including a mark; and
a backlight controller that controls the backlight so as to illuminate areas other than an area including the mark on the specific image with less brightness than a brightness of the area including the mark, in the case where the image is determined to be the specific image.

2. The display apparatus according to claim 1, wherein
the display apparatus is installed on a vehicle, and
the specific image is a car navigation image and the mark is a vehicle location mark included in the car navigation image.

3. The display apparatus according to claim 2, further comprising:
an image controller that sets an external area other than an area within a predetermined range centered on the vehicle location mark on the car navigation image, to a black image, wherein
the backlight controller controls the backlight so as to illuminate the black image with a lower intensity than the area including the mark.

4. The display apparatus according to claim 3, wherein
the image controller prohibits the external area including a route line from being set to the black image, in the case where the route line to a destination is included in the external area.

5. The display apparatus according to claim 3, wherein
the car navigation image is a map image on which the north direction is always indicated in the upper part when the car navigation image is displayed on the screen, and
the image controller prohibits the external area existing in a travelling direction from being set to the black image, in the case where the external area exists in the travelling direction indicated by the vehicle location mark.

6. The display apparatus according to claim 2, further comprising:
an image controller that reduces a size of the car navigation image and sets a black image to a blank area caused by a reduced size of the car navigation image resulting from the reduction in the size of the car navigation image, wherein
the backlight controller controls the backlight so as to illuminate the black image with a lower intensity than the area including the mark.

7. The display apparatus according to claim 6, wherein
the image controller increases a reduction ratio of the car navigation image with an increase in distance from the vehicle location mark.

8. The display apparatus according to claim 1, wherein
the specific image is a menu image for selecting any one of a plurality of functions, and
the mark is a selection mark corresponding to each of the plurality of functions.

9. The display apparatus according to claim 1, further comprising:
an image controller that corrects brightness of the specific image to be displayed so that the area illuminated with less brightness than the brightness of the area including the mark on the specific image becomes brighter.

10. A display method for displaying an image on a screen, the method comprising the steps of:
(a) determining whether or not the image to be displayed on the screen is a specific image including a mark; and
(b) controlling a backlight that illuminates the screen and that includes a plurality of light sources so as to illuminate areas other than an area including the mark on the specific image with less brightness than a brightness of the area including the mark, in the case where the image is determined to be the specific image by the step (a).

11. The display method according to claim 10, wherein
the display method is implemented in a vehicle, and
the specific image is a car navigation image and the mark is a vehicle location mark included in the car navigation image.

12. The display method according to claim 11, further comprising the step of:
(c) setting an external area other than an area within a predetermined range centered on the vehicle location mark on the car navigation image, to a black image, wherein
the step (b) controls the backlight so as to illuminate the black image with a lower intensity than the area including the mark.

13. The display method according to claim 12, wherein
the step (c) prohibits the external area including a route line from being set to the black image, in the case where the route line to a destination is included in the external area.

14. The display method according to claim 12, wherein
the car navigation image is a map image on which the north direction is always indicated in the upper part when the car navigation image is displayed on the screen, and
the step (c) prohibits the external area existing in a travelling direction from being set to the black image, in the case where the external area exists in the travelling direction indicated by the vehicle location mark.

15. The display method according to claim 11, further comprising the step of:
(d) reducing a size of the car navigation image and setting a black image to a blank area caused by a reduced size of the car navigation image resulting from the reduction in the size of the car navigation image, wherein
the step (b) controls the backlight so as to illuminate the black image with a lower intensity than the area including the mark.

16. The display method according to claim 15, wherein
the step (d) increases a reduction ratio of the car navigation image with an increase in distance from the vehicle location mark.

17. The display method according to claim 10, wherein
the specific image is a menu image for selecting any one of a plurality of functions, and
the mark is a selection mark corresponding to each of the plurality of functions.

18. The display method according to claim 10, further comprising the step of
(e) correcting brightness of the specific image to be displayed so that the area illuminated with less brightness than the brightness of the area including the mark on the specific image becomes brighter.
